(19) United States
(12) Patent Application Publication
(10) Pub. No.: US 2020/0094360 A1
(43) Pub. Date: Mar. 26, 2020

(54) DYNAMIC MOUNT FOR LOCATING AND COMPONENTS

(71) Applicant: PHD, Inc., Fort Wayne, IN (US)

(72) Inventor: Paul Nicholson, Columbia City, IN (US)

(73) Assignee: PHD, Inc., Fort Wayne, IN (US)

(21) Appl. No.: 16/580,682

(22) Filed: Sep. 24, 2019

Related U.S. Application Data
(60) Provisional application No. 62/735,323, filed on Sep. 24, 2018.

(51) Int. Cl. B23Q 1/00; B23Q 3/06; B25B 5/08; B25B 5/16

(52) U.S. Cl. CPC B23Q 1/009; B23Q 3/06; B23Q 2703/02; B25B 5/166; B25B 5/08

(57) ABSTRACT

A dynamic mount for a manufacturing apparatus, the dynamic mount including a housing, an actuation assembly and a support assembly. The housing includes a first axis along a length of the housing and a second axis along a height of the housing, the second axis being perpendicular to the first axis. The actuation assembly is movable along the first axis. The support assembly having a first portion moving between a first position and a second position along the second axis as the actuation assembly moves along the first axis. The first portion of the support assembly prohibiting movement of a second portion of the support assembly when in the first position. The second portion of the support assembly having six degrees of freedom when the first portion is in the second position.

### Cross Reference To Related Applications

This is a non-provisional application based upon U.S. provisional patent application Ser. No. 62/735,323, entitled “DYNAMIC MOUNT FOR LOCATING AND WORKHOLDING COMPONENTS”, filed Sep. 24, 2018, which is incorporated herein by reference.

### BACKGROUND OF THE INVENTION

### 1. Field of the Invention

The present invention provides a mount for holding a workpiece.

### 2. Description of the Related Art

Work holding and locating components are used in a variety of applications throughout the manufacturing industry. These components may include devices such as stationary pins, pin clamps and grippers. Primarily, these components are mounted to a static fixture and utilized as a means of locating and/or holding workpieces during assembly.

Often during an operation in the manufacturing process, a locating component becomes over-constrained. A result of this is a binding condition occurring between the precise locating components making the assembled parts difficult to remove from the work holding device. These assembled components can shift in direction (due to a welding operation for example) enough to cause deflection or warpage within the assembly. This change in a workpiece may render a component scrap because it cannot be easily removed from the work holding device without destructive means to the workpiece or work holding device.

What is needed in the art is a work-holding device that secures a workpiece, yet allows for the easy removal of the workpiece.

### SUMMARY OF THE INVENTION

The present invention provides a mechanical device that eliminates difficulties in the removal of a completed workpiece. When a work holding device or locator is mounted, this mechanism when actuated, allows the work holding or locating component to transform from a static condition to a dynamic condition. This change allows the work holding component to translate and rotate after the components have been assembled to assist in removal of the workpiece from the work holding or locating components. Once removal of the workpiece is completed, the mount device can be actuated back to its static condition. This dynamic mount assembly may work in combination with pin clamps, locating pins, grippers or other means of precision part locating for manufacturing.

The invention in one form is a dynamic mount for a manufacturing apparatus, the dynamic mount including a housing, an actuation assembly and a support assembly. The housing includes a first axis along a length of the housing and a second axis along a height of the housing, the second axis being perpendicular to the first axis. The actuation assembly is movable along the first axis. The support assembly having a first portion moving between a first position and a second position along the second axis as the actuation assembly moves along the first axis. The first portion of the support assembly prohibiting movement of a second portion of the support assembly when in the first position. The second portion of the support assembly having six degrees of freedom when the first portion is in the second position.

An advantage of the present invention is that a workpiece is securely mounted to the dynamic mount when the actuation assembly is in one position and the workpiece is movable or removable when the actuation assembly is in another position.

Another advantage of the present invention is that the support assembly can be coupled to clamps and grabbers.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a mount mechanism of the present invention;

FIG. 2 is an exploded view of the mount mechanism of FIG. 1;

FIG. 3 is a perspective view of the internal working components of the mount mechanism of FIGS. 1 and 2 in an extended (Dynamic) condition;

FIG. 4 is a cross-sectional view, taken along 4-4 of FIG. 3, depicting the relationship between the locating cup and lower support of the mount mechanism of FIGS. 1-3, in the extended (Dynamic) condition;

FIG. 5 is a perspective view of the internal working components of the mount mechanism of FIGS. 1-4, in a retracted (Static) condition;

FIG. 6 is a cross-sectional view, taken along 6-6 of FIG. 5, depicting the relationship between the locating cup and lower support of the mounting mechanism of FIGS. 1-5, in the retracted (Static) condition;

FIG. 7 is a cross-sectional view, taken along 7-7 of FIG. 2, depicting the relationship between the housing and pin contained in the lower support of the mounting mechanism of FIGS. 1-6, in the extended (Dynamic) condition;

FIG. 8 illustrates a lower view of the housing and pin of the mounting mechanism of FIGS. 1-7;

FIG. 9 illustrates a pin clamp mounted to the top of the mount mechanism of FIGS. 1-8;

FIG. 10 shows a static pin mounted to the mount mechanism of FIGS. 1-9;

FIG. 11 is a perspective view of another embodiment of a mount mechanism of the present invention, similar in many regards to that of FIG. 1;

FIG. 12 is an exploded view of the mount mechanism of FIG. 11;

FIG. 13 is a perspective view of the internal working components of the mount mechanism of FIGS. 11 and 12 in an extended (Dynamic) condition;

FIG. 14 is a cross-sectional view, taken along 14-14 of FIG. 13, depicting the relationship between the locating cup and lower support of the mount mechanism of FIGS. 11-13, in the extended (Dynamic) condition;

FIG. 15 is a side view of the internal working components of the mount mechanism of FIGS. 11-14, in an extended (Dynamic) condition;

FIG. 16 is a cross-sectional view, taken along 16-16 of FIG. 15, depicting the relationship between the locating cup and lower support of the cam members of FIGS. 11-15, in the extended (Dynamic) condition, and particularly there is a view of the relationship between the cam members containing detent slots and the lower support;

FIG. 17 is a perspective view of the internal working components of the mount mechanism of FIGS. 11-16 in a retracted (Static) condition, and particularly there is a view of the relationship between the cam members and the ball detents;

FIG. 18 is a cross-sectional view, taken along 18-18 of FIG. 17, depicting the relationship between the locating cup and lower support of the mount mechanism of FIGS. 11-17, in the retracted (Static) condition;

FIG. 19 is a side view of the internal working components of the mount mechanism of FIGS. 11-18, in the retracted (Static) condition; and

FIG. 20 is a cross-sectional view, taken along 20-20 of FIG. 19, depicting the relationship between the cam members containing detent slots and the lower support in the retracted (Static) condition.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

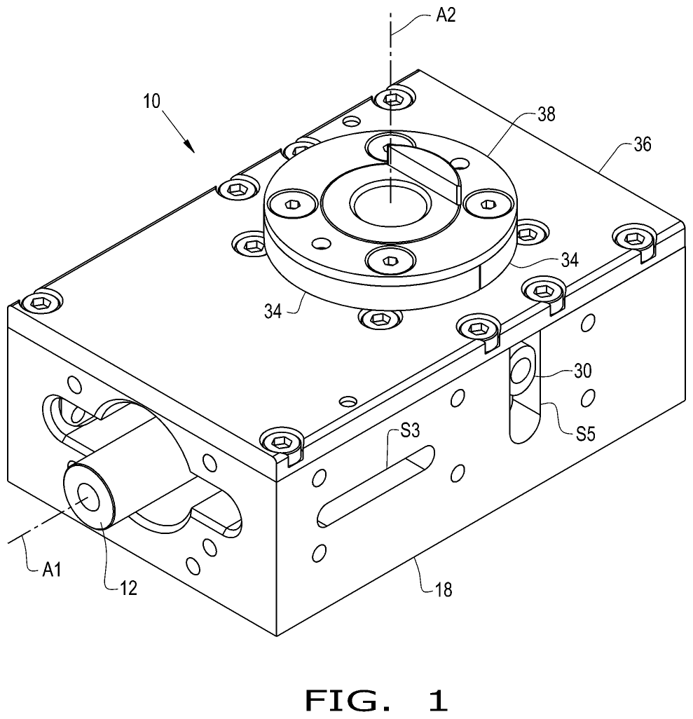

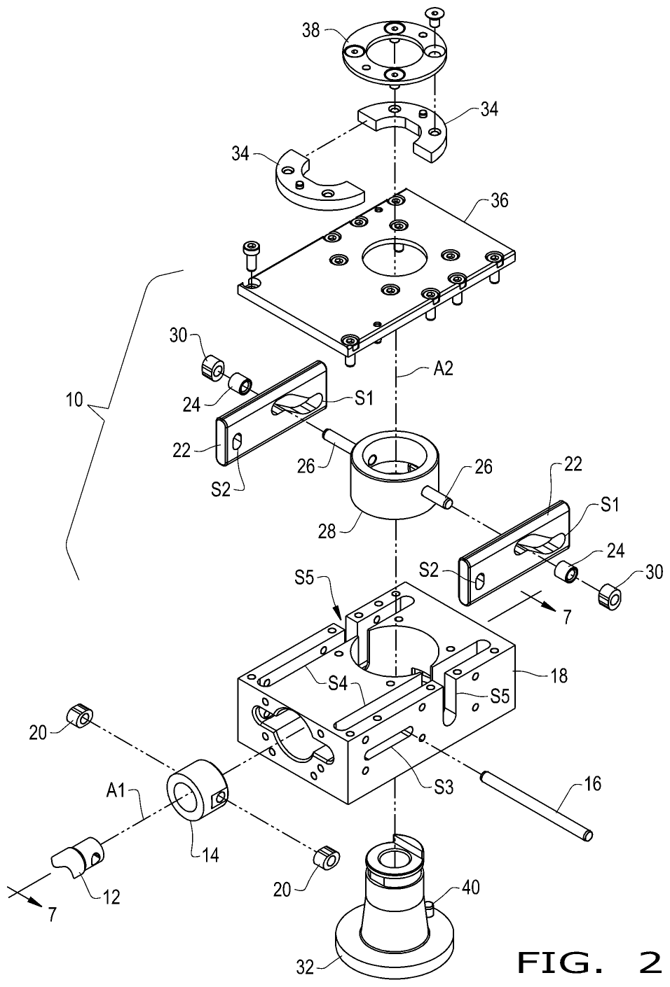

Referring now to the drawings, and more particularly to FIGS. 1 and 2, there is shown one embodiment of a mount mechanism 10 including a rod 12, a spacer 14, a pin 16, a housing 18, slider bushings 20, cam members 22, rollers 24, pins 26, a locating cup 28, slider bushings 30, a lower support 32, retainer supports 34, a housing cover 36, a retainer ring 38, and a pin 40. The rod 12 is actuated in a linear direction by way of an actuator using pneumatics, hydraulics, or electromechanics, or may be manually moved. Rod 12 is attached to pin 16 located within housing 18. Spacer 14 aids in positioning rod 12. Pin 16 moves in the same direction as rod 12 but pin 16 is prevented from moving in any other direction by way of slider bushings 20, which travel in complimentary slots inside of housing 18. Slider bushings 20 are separated by spacer 14. Pin 16 transfers force to complimentary slots S2 positioned inside cam members 22.

Cam members 22 are slidingly contained within slots in housing 18. Cam members 22 move linearly in the same direction as rod 12, pin 16, slider bushings 20 and spacer member 14. A cam slot 51 is positioned inside each of cam members 22 containing rollers 24. Rollers 24 are confined by geometry to move inside the cam slots. Rollers 24 only move in a vertical direction within cam slots 51 as cam members 22 move in a linear horizontal direction. Each roller 24 rotates around pin 26, which are attached to either side of locating cup 28.

Pins 26 on each side of cup 28 are positioned to move vertically with rollers 24 and are located by additional slider bushings 30. Slider bushings 30 are directed vertically within vertically oriented slots S5 of housing 18. Rollers 24 move vertically contingent upon the actuation of each cam member 22. Each roller 24, containing a pin 26, causes locating cup 28 to move in the vertical direction (axis A2 direction). Locating cup 28 is geometrically formed so that it receives a lower support 32 of a complimentary geometry.

This geometric relationship causes lower support 32 to remain in a fixed position axially and radially when in a retracted condition. When locating cup 28 is extended, cup 28 disengages the complimentary geometry of lower support 32 thus allowing limited rotation of lower support 32 about its' axis and limited radial movement, in six degrees of freedom.

The lower support 32 may contain pin 40 to assist in limiting rotation when lower support 32 is not engaged with locating cup 28. Pin 40 contained in lower support 32 is limited in movement by the geometry in the lower portion of housing 18. This geometry in housing 18 prevents the over-rotation of movement of lower support 32 in the extended (Dynamic) condition. Pin 40 may also be used as a guide, when engaging locating cup 28, as mechanism 10 transfers to the retracted (Static) condition.

Lower support 32 is held in position vertically by housing 18 and by retainer supports 34 on the outside of housing cover 36. Retainer supports 34 are mounted on either side of lower support 32 and are contained with retainer ring 38.

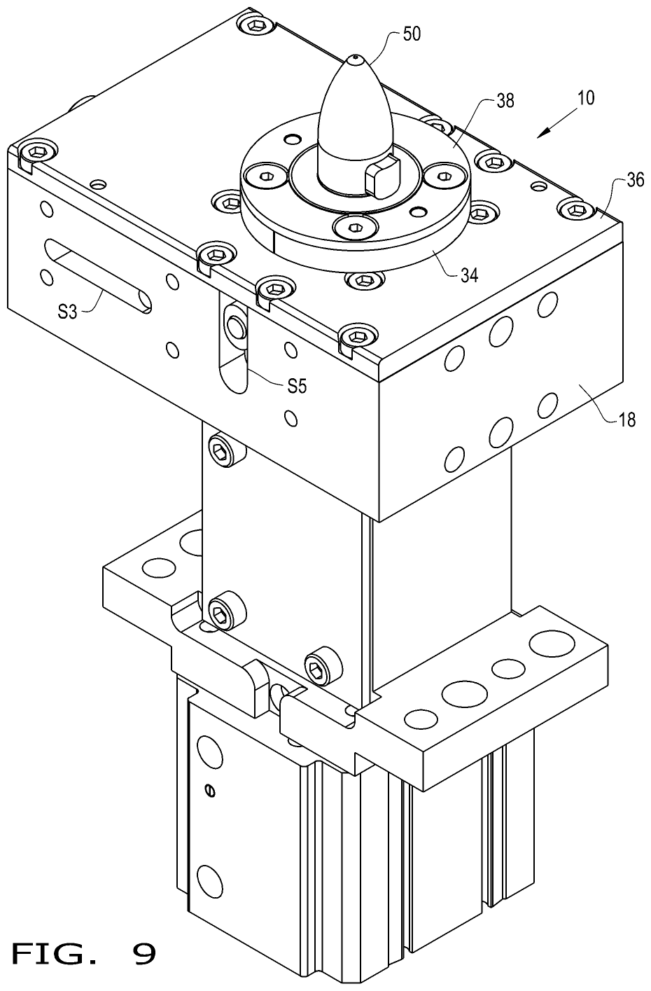

Any device mounted to lower support 32 cannot move when the dynamic mount 10 is in the retracted (Static) condition. When mount 10 is actuated to the Dynamic condition, a mounted device may rotate about its' axis or move radially within a limited amount of freedom. This allowance in positional movement assists in removal of any assembly that was being located by the device mounted to the lower support 32. This lower support 32 is not limited to stationary tooling but may have additional geometry included to accept items such as a pin clamp 20, illustrated in FIG. 9.

A spring (not shown) may be used to assist rod 12 to actuate in either direction to ensure internal components do not move until the opposing force of the spring is overcome.

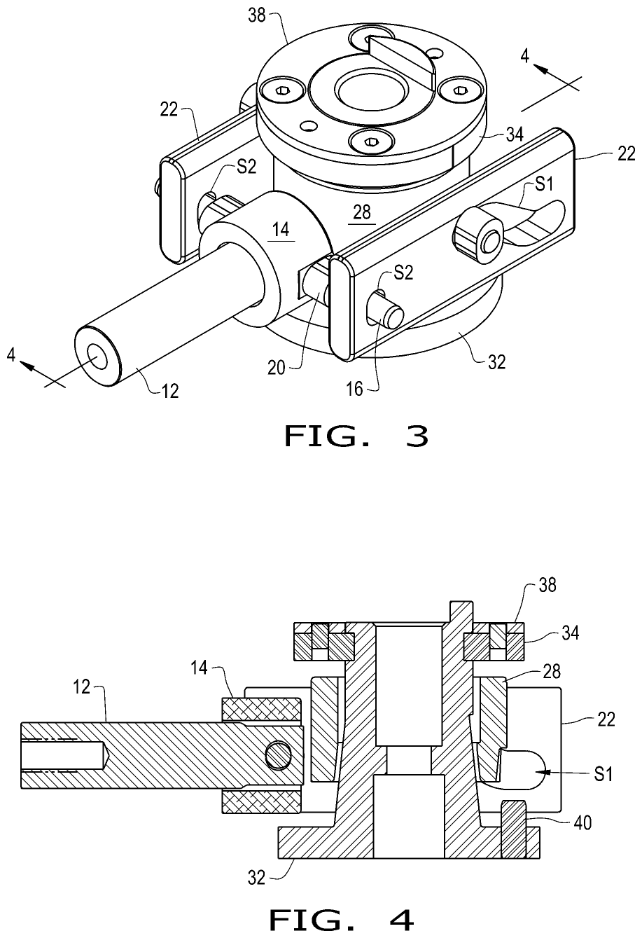

Now, additionally referring to FIGS. 3 and 4, internal working components of mount mechanism 10 are illustrated in a perspective view (FIG. 3) and in a cross-sectional view (FIG. 4), in an extended (Dynamic) condition. The cross-sectional view of FIG. 4 depicts the relationship between locating cup 28 and lower support 32 when mount mechanism 10 is in the extended (Dynamic) condition, with locating cup 28 in a raised position.

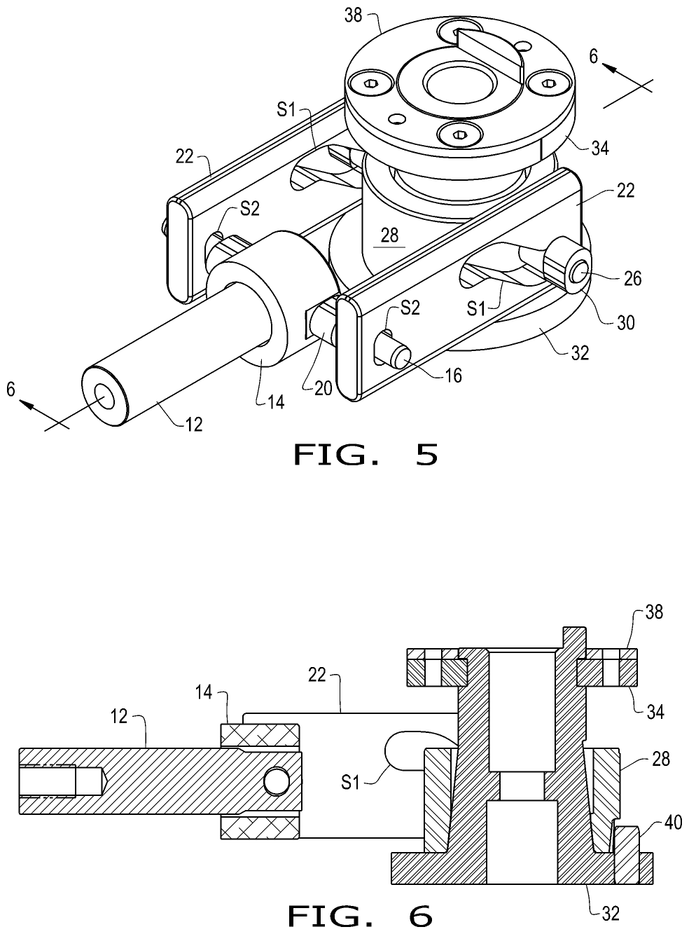

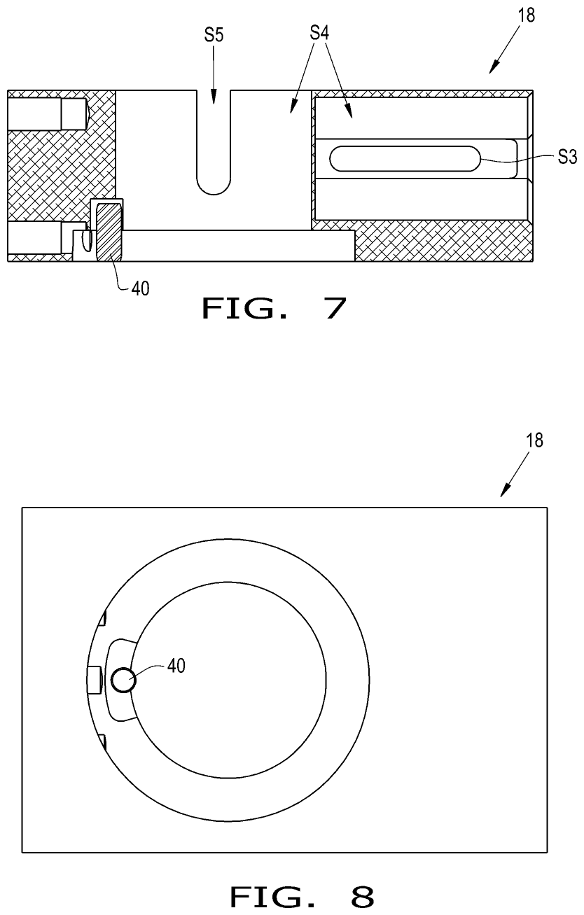

Now, additionally referring to FIGS. 5 and 6 there is illustrated, in a perspective view (FIG. 5) and in a cross-sectional view (FIG. 6), the internal working components of mount mechanism 10 in a retracted (Static) condition. The cross-sectional view of FIG. 6 depicts the relationship between locating cup 28 and lower support 32 of mounting mechanism 10 in the retracted (Static) condition. This relationship includes a mating of part of the internal geometry of locating cup 28 with a portion of the external geometry of lower support 32, specifically tapered portions. Further, looking to FIG. 7 there is shown a cross-sectional view depicting the relationship between housing 18 and pin 40 contained in lower support 32, when mounting mechanism 10 is in the extended (Dynamic) condition. Additionally, FIG. 8 illustrates a lower view of housing 18 and pin 40 of mounting mechanism 10.

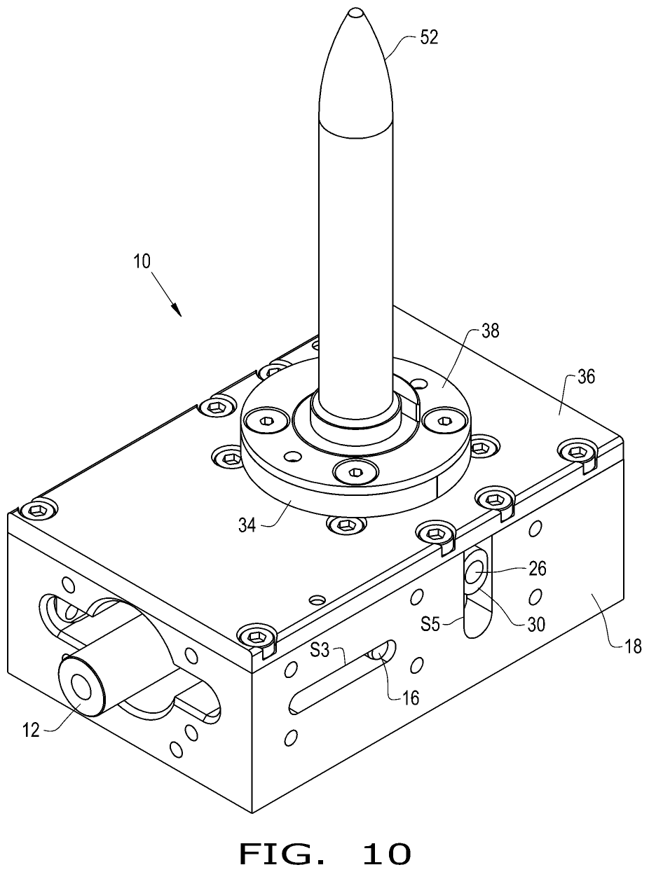

FIG. 9 illustrates a pin clamp 50 mounted to the top of mount mechanism 10, and FIG. 10 shows a static pin 52 mounted to mount mechanism 10.

Cam members 22 each include slots 51 and S2. Slot 51 has a profile in which cam roller 24 rides and the shape of slot 51 provides for the vertical movement along axis A2 of locating cup 28, as cam members 22 move parallel to axis A1. Slot S2 is a vertical slot that allows for movement in the direction of axis A2 of cam member 22 relative to pin 16 which extending through slot S2.

Housing 18 includes slots S3, S4 and S5. Slots S3 are horizontal and are parallel with axis A1. Slots S3 are on each side of housing 18 and pin 16 extends therethrough. Pin 16 additionally extends through slots S2 of cams 22. Slots S4 can also be thought of as elongated cavities in which cams 22 move both horizontally and vertically. Slots S3 and S5 extend through respective slots S4. Slots S5 are vertical open-ended slots within which slider bushings 30 operate. Housing cover 36 serves to enclose the open end of slots S5 as well as slots S4. Pin 16 extends through slots S2, S3 and S4 on each side of housing 18. Each pin 26 extends through slots S1, S4 and S5 on one side of housing 18, with each pin 26 having roller 24 and bushing 30, respectively contacting slots S1 and S5.

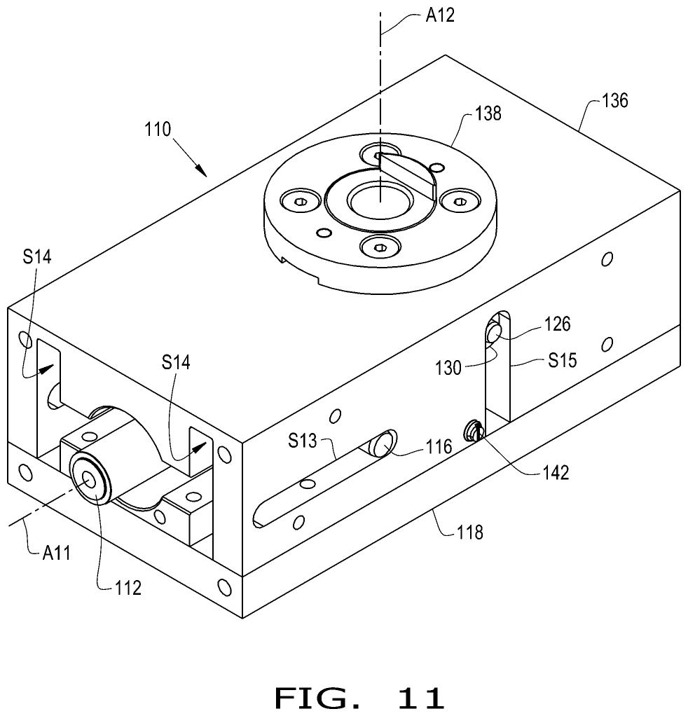

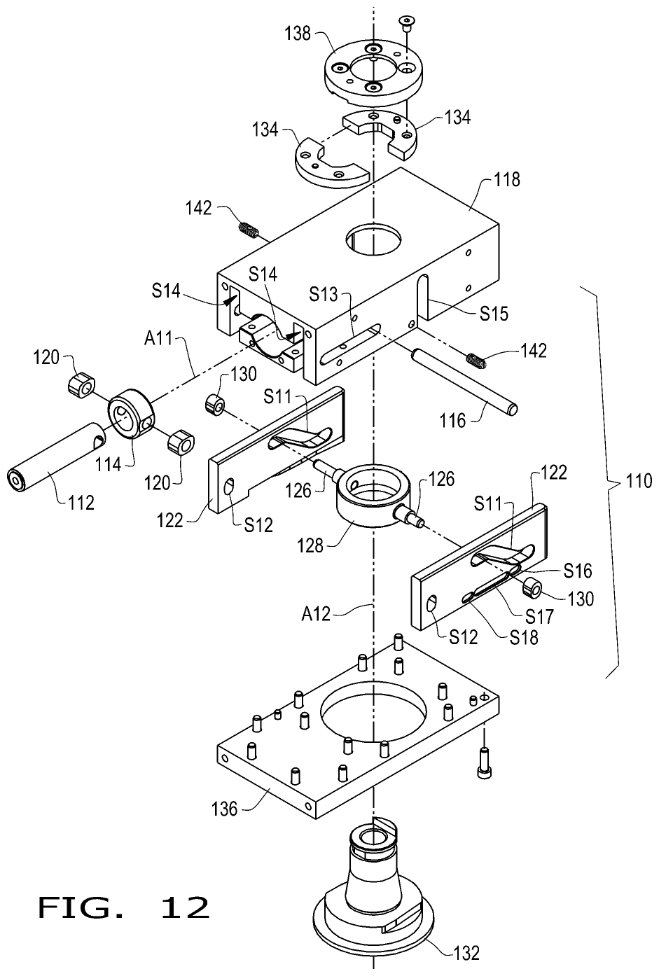

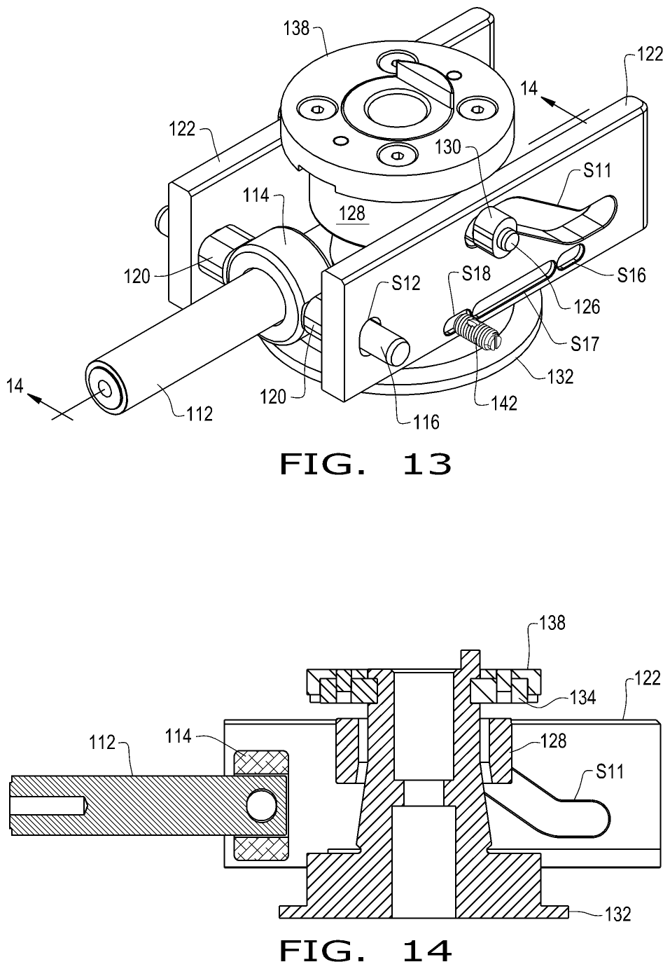

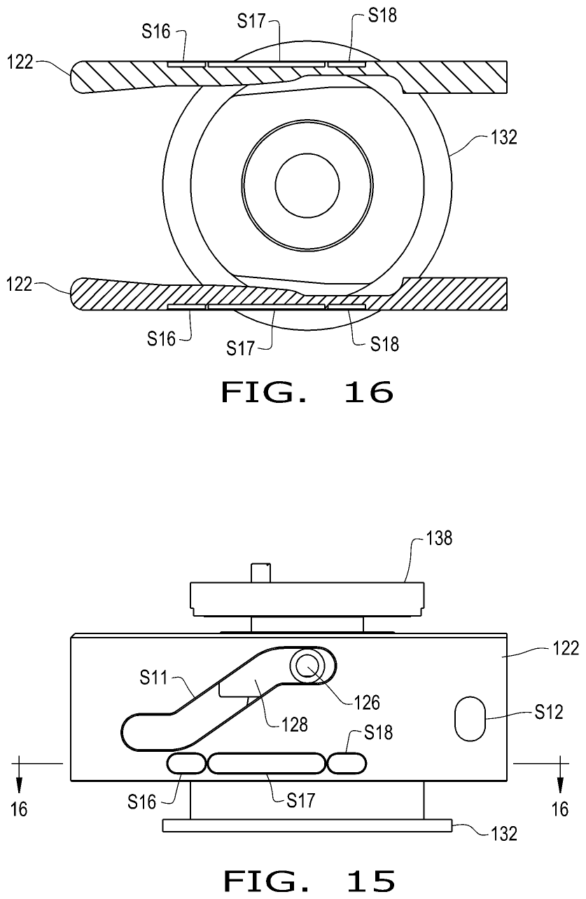

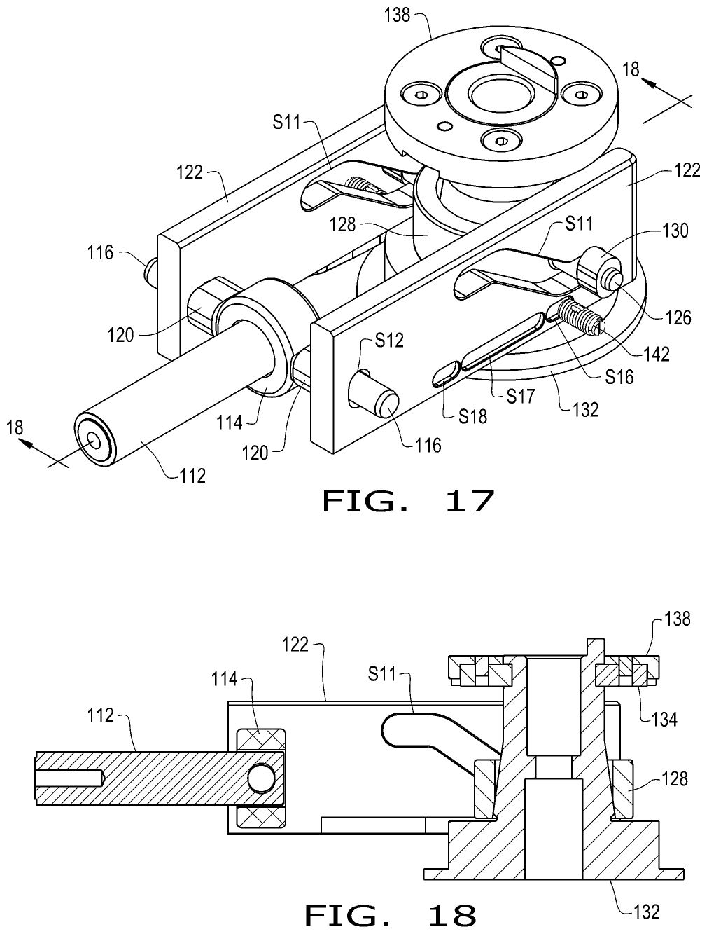

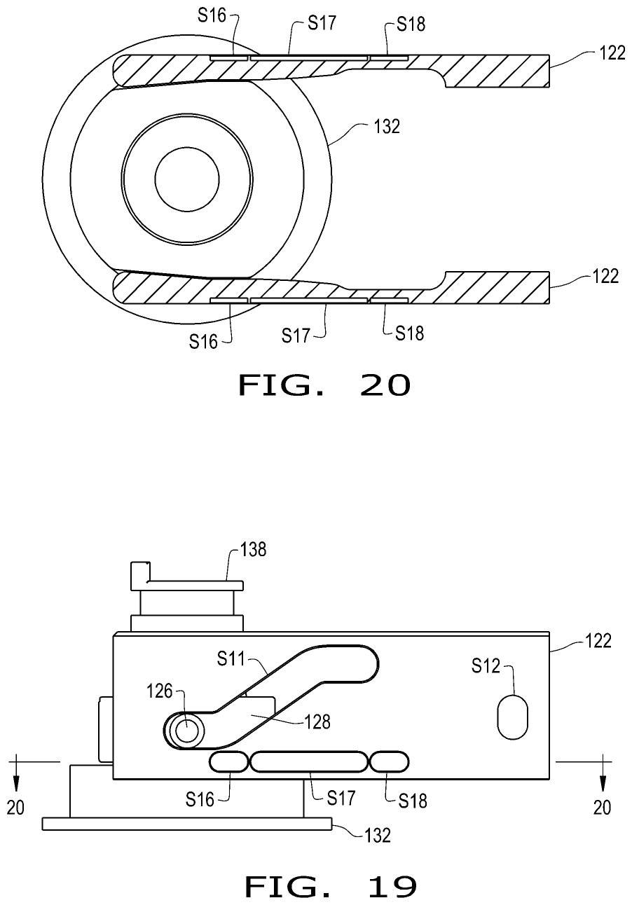

Now, additionally referring to FIGS. 11-20 there is illustrated another embodiment of a mount mechanism 110 of the present invention. Here reference numbers have been incremented by 100 and those reference characters that start with a letter ('A′ and ‘S’) have been incremented by 10 relative to those in FIGS. 1-10 thereby identifying corresponding parts. The characteristics, discussed above, of items will generally also apply to the elements in FIGS. 11-20 that have the corresponding numbers with the offsets.

Rod 112 is actuated in a linear direction by means of pneumatics, hydraulics, electro-mechanics or manually. Rod 112 is attached to pin 116 located within housing 118. Spacer 114 aids in positioning of rod 112. Pin 116 moves in the same direction as rod 112 but is prevented from moving in any other direction by means of slider bushings 120 traveling in complimentary slots S13 inside housing 118. Slider bushings 120 are separated by spacer 114. Pin 116 transfers force to complimentary slots S12 positioned inside cam members 122.

Cam members 122, which are mirror images of each other, are contained within slots S14 in housing 118. Cam members 122 move linearly in the same direction, along axis A11 as rod 112, pin 116, slider bushings 120 and spacer 114. A slot S11 is positioned inside each of cam members 122. The cam slots S11 confine pins 126 on either side of locating cup 128. Cup 128 only moves vertically, along axis A12, which is substantially perpendicular to axis A11, and cup 128 is confined inside of housing 118. Pins 126 on each side of cup 128 are positioned to move vertically, in direction A12, with cup 128 and are located by additional slider bushings 130. These slider bushings 130 are directed vertically within vertical slots S15 of housing 118. Cup 128 moves vertically in a direction A12 contingent upon the actuation of cam members 122. Cup 128 contains geometry that receives lower support 132 of complimentary geometry.

Lower support 132 also contains geometry complimentary to cam members 122. When mount mechanism 110 is in the extended condition, cam members 122 limit rotation of lower support 132. When in the retracted condition, cam members 122 prevent rotation of lower support 132. These geometric relationships cause lower support 132 to remain in a fixed position axially and radially when cup 128 is held in the retracted condition.

When locating cup 128 is extended, it disengages with the complimentary geometry of lower support 132. The extended position of cam members 122 thus allow limited rotation of lower support 132 about its' axis and limited radial movement.

Ball detent springs 142 are positioned in housing 118 and are sequenced to engage slots S16, S17 and S18 in cam members 122. This sequencing of slots S16, S17 and S18 to ball detent springs 142 allows each cam member 122 to remain in its desired position. Once the force required to overcome each ball detent spring 142 has been reached, cam members 122 are able to move to their next desired location linearly. Thus, cam members 122 are not free to inadvertently migrate to an undesired location until enough force on rod 112 has been incurred on each ball detent spring 142. The result of cam members 122 being unable to move freely creates a locking condition for cup 128 and lower support 132. Additionally, ball detent springs 142 will not allow cam members 122 to move from the extended (Dynamic) condition to the retracted (Static) condition until the overcoming force requirement has been achieved.

Lower support 132 is held in position vertically by lower cover 136, housing 118 and by retainer supports 134. Retainer supports 134 are mounted above housing 118 and are located on either side of lower support 132. Retainer supports 134 are contained within retainer ring 138. Suitable fasteners retain retainer ring 138 to retainer supports 134. Also, suitable fasteners are used to retain lower cover 136 to housing 118.

Any device mounted to lower support 132 cannot move when mount 110 is in the retracted (Static) condition. When mount 110 is actuated to the extended (Dynamic) condition, a mounted device may rotate a limited amount about its' axis or move radially within a limited amount of freedom, allowing six degrees of freedom of movement. This allowance in positional movement assists in removal of any assembly that was being located by the device mounted to the lower support 132. This lower support 132 is not limited to stationary tooling but may have additional geometry included to accept items such as a pin clamp 50 or gripper.

A spring (not shown) may also be used to assist rod 112 to actuate in either direction, along axis A11, to ensure internal components do not move until the opposing force of the spring is overcome.

Dynamic mount 10 includes a housing 18 with first axis A1 along a length of housing 18 and a second axis A2 along a height of the housing, the second axis A2 being substantially perpendicular to first axis A1. Mount 10 also includes an actuation assembly movable along the first axis A1. Mount 10 also includes a support assembly (collectively 28, 32, 34 and 38) having a first portion 28 moving between a first position (see FIG. 6) and a second position (see FIG. 4) along the second axis A2 as the actuation assembly moves along the first axis A1. The first portion 28 of the support assembly 28, 32, 34, 38 prohibiting movement of a second portion 32, 34, 38 of the support assembly when in the first position (see FIG. 6), the second portion 32, 34, 38 of the support assembly having six degrees of freedom when the first portion 28 is in the second position (see FIG. 4).

The first portion 28 of the support assembly being a locating cup 28 having an inner surface engaging the second portion 32 of the support assembly when in the first position (FIG. 6). The locating cup 28 further having a plurality of holes shaped and sized for a plurality of pins 26, wherein the plurality of pins 26 have a first end that inserts into at least one of the plurality of holes and an opposite end having at least one cam roller 24 and at least one slider bushing 30. The at least one cam roller 24 engages the actuation assembly and the at least one slider bushing 30 engages housing 18.

The second portion 32, 34, 38 of the support assembly includes retainer ring 38, retainer supports 34 and lower support 32 having a first end and a second end, the first end having an outer surface configured to engage the first portion 28 of the support assembly when first portion 28 of the support assembly is in the first position (FIG. 6), the second end configured to attach to the plurality of retainer supports 34 and the retainer ring 38. The retainer supports 34 are configured to limit linear movement of lower support 32 in the second axis, and retainer ring 38 is configured for attaching to a manufacturing fixture.

The actuation assembly includes a plurality of cam members 22 each having a cam slot S1 formed therein and a slotted hole S2. Cam members 22 are arranged to move along the first axis A1 of housing 18 in slots S4. The actuation assembly also includes actuation pin 16 configured to engage hole S2 of cam members 22 and slide within housing 18 at actuation pin slot S3 shaped and sized for actuation pin 16. Actuation pin 16 is disposed generally traverse to first axis A1 and to second axis A2 of housing 18. The actuation assembly also includes spacer member 14 having a through hole adapted for actuation pin 16. Spacer member 14 further including an inner surface disposed essentially longitudinal to first axis A1 and configured for attaching actuation rod 12. Actuation rod 12 may be provided with a biasing member to bias actuation rod 12 to a position. The actuation assembly also includes a plurality of slider bushings 20 arranged at opposite ends of actuation pin 16 and configured to slide within housing 18 at a slider bushing slot, within housing 18, shaped and sized for the plurality of slider bushings 20, the slider bushing slot being arranged longitudinal to first axis A1.

The first end of lower support 32 includes an element 40, in the form of a pin 40, to prevent over rotation of lower support 32 in the second position and to engage the locating cup 28 when in the first position (see FIG. 6).

The manufacturing fixture includes pin clamps 50, locating pins, grippers or other devices adapted for precision part locating.

As shown, cam slots 51 of each of the cam members 22 have the same profile, which interacts with bushing 30 causing cup 28 to directionally move along axis A2. Slotted holes S2 of the cam members 22 allow movement of actuation pin 16 relative to cam members 22 in the direction of the second axis A2. Cam members 122 additionally include at least one detent slot S16, S17 and S18, that interact with ball detent 142 to detain the cam member in a position, which serve to keep the actuation assembly in a particular location until force is applied to rod 12 to overcome the retention of detent 142. Detent slots S16, S17 and S18 are in a linear path. The ball detents 142 are configured to interact with the plurality of detent slots S16, S17, S18 as cam members 122 are moved in a linear direction A1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A dynamic mount for a manufacturing apparatus, the dynamic mount comprising:
a housing including a first axis along a length of the housing and a second axis along a height of the housing, the second axis being substantially perpendicular to the first axis;
an actuation assembly movable along the first axis; and
a support assembly having a first portion moving between a first position and a second position along the second axis as the actuation assembly moves along the first axis, the first portion of the support assembly prohibiting movement of a second portion of the support assembly when in the first position, the second portion of the support assembly having six degrees of freedom when the first portion is in the second position.

2. The dynamic mount of claim 1, wherein the first portion of the support assembly includes a locating cup having an inner surface engaging the second portion of the support assembly when in the first position, the locating cup further having a plurality of holes shaped and sized for a plurality of pins, wherein the plurality of pins have a first end that inserts into at least one of the plurality of holes and an opposite end having at least one cam roller and at least one slider bushing, wherein the at least one cam roller engages the actuation assembly and the at least one slider bushing engages the housing.

3. The dynamic mount of claim 1, wherein the second portion of the support assembly includes a retainer ring, a plurality of retainer supports and a lower support having a first end and a second end, the first end having an outer surface configured to engage the first portion of the support assembly when the first portion of the support assembly is in the first position, the second end configured to attach to the plurality of retainer supports and the retainer ring, the retainer supports configured to limit linear movement of the lower support in the second axis, and the retainer ring configured for attaching to a manufacturing fixture.

4. The dynamic mount of claim 1, wherein the actuation assembly includes:
a plurality of cam members each having a cam slot formed therein and a slotted hole, the plurality of cam members being arranged to move along the first axis of the housing;
an actuation pin configured to engage the hole of the plurality of cam members and slide within the housing at an actuation pin slot shaped and sized for the actuation pin, the actuation pin being disposed generally traverse to the first axis and to the second axis of the housing;
a spacer member having a through hole adapted for the actuation pin, the spacer member further including an inner surface disposed essentially longitudinal to the first axis and configured for attaching an actuation rod; and
a plurality of slider bushings arranged at opposite ends of the actuation pin and configured to slide within the housing at a slider bushing slot shaped and sized for the plurality of slider bushings, the slider bushing slot being arranged longitudinal to the first axis.

5. The dynamic mount of claim 3, wherein the first end of the lower support includes an element to prevent over rotation of the lower support in the second position and to engage the locating cup when in a first position.

6. The dynamic mount of claim 5, further comprising a plurality of cam members that limit rotation of the lower support when the dynamic mount is in a dynamic condition, and the cam members prevent rotation of the lower support when the dynamic mount is in a static condition.

7. The dynamic mount of claim 3, wherein the manufacturing fixture includes pin clamps, locating pins, grippers or other devices adapted for precision part locating.

8. The dynamic mount of claim 4, wherein the actuation rod is further provided with a biasing member to bias the actuation rod to a position.

9. The dynamic mount of claim 4, wherein the cam slots of each of the plurality of cam members have the same profile.

10. The dynamic mount of claim 4, wherein the slotted holes of the cam members allow movement of the actuation pin relative to the cam members in the direction of the second axis.

11. The dynamic mount of claim 4, wherein the cam members additionally include at least one detent slot.

12. The dynamic mount of claim 11, further comprising at least one ball detent that interacts with the at least one detent slot to detain the cam member in a position.

13. The dynamic mount of claim 12, wherein the at least one detent slot is a plurality of detent slots in a linear path, the at least one ball detent being configured to interact with the plurality of detent slots as the cam member is moved in linear direction.

14. A dynamic mount system for a manufacturing apparatus, the system comprising:
a clamp apparatus; and
a mount mechanism including:
a housing including a first axis along a length of the housing and a second axis along a height of the housing, the second axis being perpendicular to the first axis;
an actuation assembly movable along the first axis; and
a support assembly having a first portion moving between a first position and a second position along the second axis as the actuation assembly moves along the first axis, the first portion of the support assembly prohibiting movement of a second portion of the support assembly when in the first position, the second portion of the support assembly having six degrees of freedom when the first portion is in the second position.

15. The system of claim 14, wherein the actuation assembly includes:
a plurality of cam members each having a cam slot formed therein and a slotted hole, the plurality of cam members being arranged to move along the first axis of the housing;
an actuation pin configured to engage the hole of the plurality of cam members and slide within the housing at an actuation pin slot shaped and sized for the actuation pin, the actuation pin being disposed generally traverse to the first axis and to the second axis of the housing;
a spacer member having a through hole adapted for the actuation pin, the spacer member further including an inner surface disposed essentially longitudinal to the first axis and configured for attaching an actuation rod; and
a plurality of slider bushings arranged at opposite ends of the actuation pin and configured to slide within the housing at a slider bushing slot shaped and sized for the plurality of slider bushings, the slider bushing slot being arranged longitudinal to the first axis.

16. The system of claim 15, wherein the cam slots of each of the plurality of cam members have the same profile.

17. The system of claim 15, wherein the slotted holes of the cam members allow movement of the actuation pin relative to the cam members in the direction of the second axis.

18. The system of claim 15, wherein the cam members additionally include at least one detent slot.

19. The system of claim 18, further comprising at least one ball detent that interacts with the at least one detent slot to detain the cam member in a position.

20. The system of claim 19, wherein the at least one detent slot is a plurality of detent slots in a linear path, the at least one ball detent being configured to interact with the plurality of detent slots as the cam member is moved in linear direction.
